(19) United States
(12) Patent Application Publication
(10) Pub. No.: US 2012/0171637 A1
(43) Pub. Date: Jul. 5, 2012

(54) DISPOSABLE HAND-HELD DENTAL TOOL

(76) Inventor: Ming-Yuan Wu, Taipei City (TW)

(21) Appl. No.: 12/984,323

(22) Filed: Jan. 4, 2011

(51) Int. Cl. A61C 3/00

(52) U.S. Cl. 433/141

(57) ABSTRACT

A hand-held dental tool with a main body, an isolated weight inside the main body, and at least one implement. The at least one implement is partially molded inside the main body leaving part of the implement exposed. A main body cap with threads that mate with threads on the main body is provided to allow the cap to be screwed into the main body and retain the isolated weight inside an unthreaded hollow chamber of the main body. A use indicator indicates that the dental tool has been used once. As a result a patient can determine whether or not the dental tool has been previously used on another patient. The main body, implement, the use indicator, and main body cap are disposed of after a single use and the weight is kept for future use.

### BACKGROUND OF THE INVENTION

1. Field of the Invention

The present invention relates to dental equipment. More specifically, the present invention discloses a hand-held dental tool that is disposable after use in order to prevent cross-contamination between patients and eliminate the need for sterilization procedures.

2. Description of the Prior Art

Dental professionals utilize a variety of hand-held tools to perform procedures to maintain a patient's teeth and to correct dental problems.

Refer to FIG. 1 which is a drawing illustrating a dental tool of the prior art. The conventional dental tool 100 includes a solid metal body 110 with a metal implement 120 on one end of the solid metal body 110.

Since the conventional dental tool 100 is made completely of metal, the dental tool 100 has a relative weight. This weight provides a balance and makes the tool comfortable to use.

However, after each use the dental tool 100 must be sterilized before the dental tool 100 is used with another patient in order to prevent contamination and possible infection or bacteria from being spread between patients. For example, if patient A has a virus and the dental tool used with patient A is not sterilized before using the dental tool with patient B, it is possible for patient B to contract the virus. As a result, use of the conventional dental tool has a potential risk of negatively affecting a patient's health.

Additionally, since the conventional dental tool is made of solid metal, the dental tool is relatively expensive to produce and purchase. Also, there is an associated cost involved with the sterilization procedure, sterilization equipment, and dental professional's time to perform the sterilization procedure.

Therefore, there is need for an improved hand-held dental tool that is disposable thus eliminating the need for a sterilization procedure.

### SUMMARY OF THE INVENTION

To achieve these and other advantages and in order to overcome the disadvantages of the conventional methods in accordance with the purpose of the invention as embodied and broadly described herein, the present invention provides a hand-held dental tool that is relatively inexpensive and is disposable after use in order to eliminate sterilization procedures and prevent contamination from being pass between patients.

The hand-held dental tool of the present invention comprises a main body, a dental implement, and a weight.

The main body comprises a malleable material such as, for example, a plastic material. The main body is molded into a suitable shape to form the body of the dental tool where the dental professional grasps during use.

The weight is molded inside the main body and provides the hand-held dental tool with a relative weight. This relative weight allows the hand-held dental tool of the present invention to feel similar to the conventional dental tool. As a result, dental professionals can easily replace the conventional dental tool with the hand-held dental tool of the present invention without changing their technique.

A portion of the implement is molded inside the main body with the remaining portion exposed or extending outside the main body. The implement comprises, for example, a hook, mirror, scraper, packer, curl, file, flattened end, pick, or trowel.

Since the main body comprises an inexpensive material the cost of the hand-held dental tool is low and allows the dental tool to be disposed of after each use.

The hand-held dental tool of the present invention further comprises a use indicator for indicating that the dental tool has been previously used. When the use indicator encounters saliva or blood the use indicator will change color or dissolve. A patient can easily visually determine whether or not the dental tool has been previously used. As a result, contamination between patients is prevented.

The present invention further comprises a molded main body and a main body cap. The molded main body comprises a hollow chamber and a threaded main body end. The main body cap further comprises cap threads for mating with the threaded main body end. A weight is inserted into the hollow chamber and the main body cap is screwed into the main body to retain the weight. After using the dental tool, the main body cap is unscrewed and the weight is removed. The main body with implement and the main body cap are then disposed of and the weight is kept for further use. Since the weight is reusable the cost of the dental tool is reduced.

The present invention further comprises a molded main body and a threaded weight. The molded main body comprises a hollow chamber and a threaded main body end. The threaded weight comprises a weight cap and weight threads for mating with the threaded main body end. The threaded weight is inserted into the hollow chamber and the weight threads are screwed into the threaded main body end of the main body to retain the threaded weight. After using the dental tool, the threaded weight is unscrewed and removed. The main body with implement is then disposed of and the threaded weight is kept for further use.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1A is a drawing illustrating a dental tool of the prior art;

FIG. 2A is a cross-sectional drawing illustrating a hand-held dental tool with a single implement and an isolated weight according to an embodiment of the present invention;

FIGS. 2B-2C are cross-sectional drawings illustrating hand-held dental tools with two implements and isolated weights according to embodiments of the present invention;

FIG. 2D is a side view drawing illustrating an angled implement of the hand-held dental tool of FIG. 2C;

FIG. 3A is a cross-sectional drawing illustrating a hand-held dental tool with a single weighted implement according to an embodiment of the present invention;

FIG. 3B is a cross-sectional drawing illustrating a hand-held dental tool with a double ended weighted implement according to an embodiment of the present invention;

FIG. 3C is a cross-sectional drawing illustrating a hand-held dental tool with a single weighted implement and a mirror according to an embodiment of the present invention;

FIGS. 4A-4D are drawings illustrating additional implements according to embodiments of the present invention;

FIG. 5A is a drawing illustrating a single ended hand-held dental tool with use indicator according to an embodiment of the present invention;

FIG. 5B is a drawing illustrating a double ended hand-held dental tool with use indicators according to an embodiment of the present invention;

FIG. 6A is a drawing illustrating a dental tool with threaded main body and main body cap according to an embodiment of the present invention; and

FIG. 6B is a drawing illustrating a dental tool with threaded main body and threaded weight according to an embodiment of the present invention.

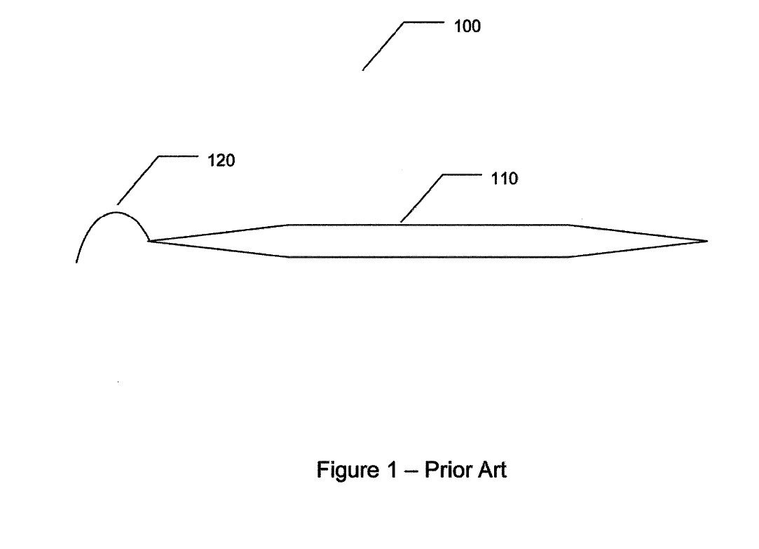

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

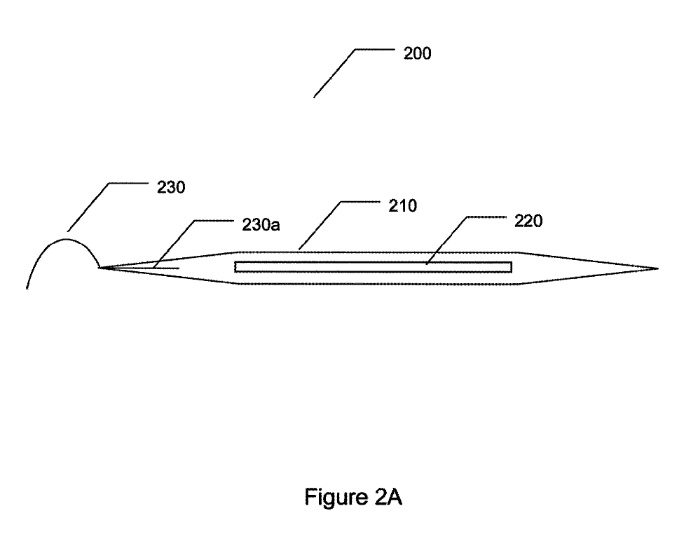

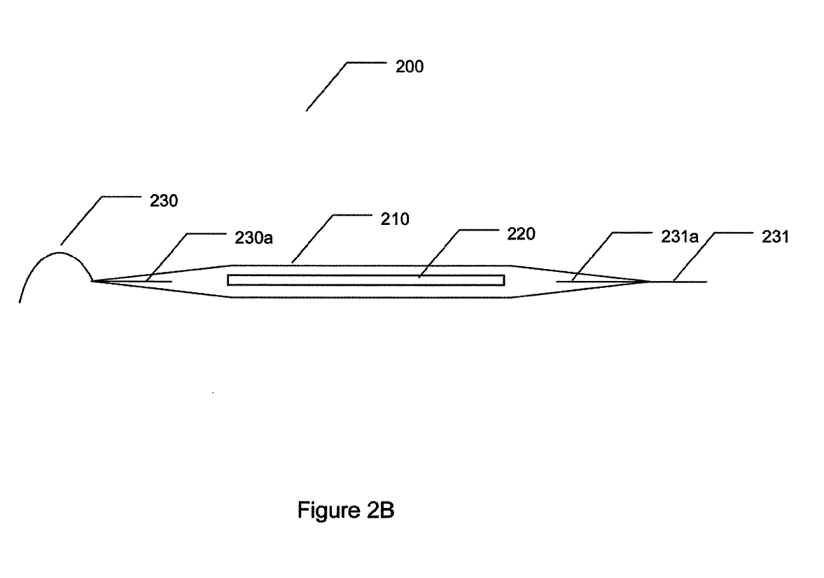

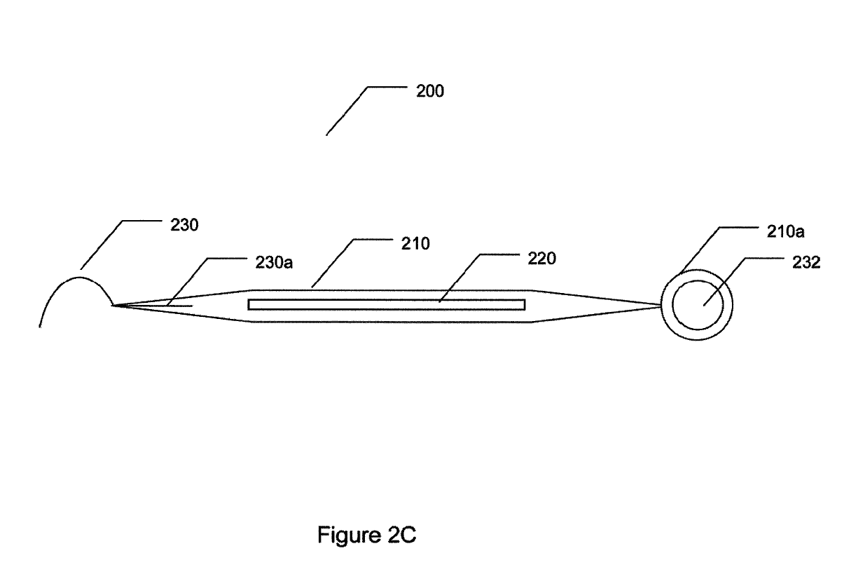

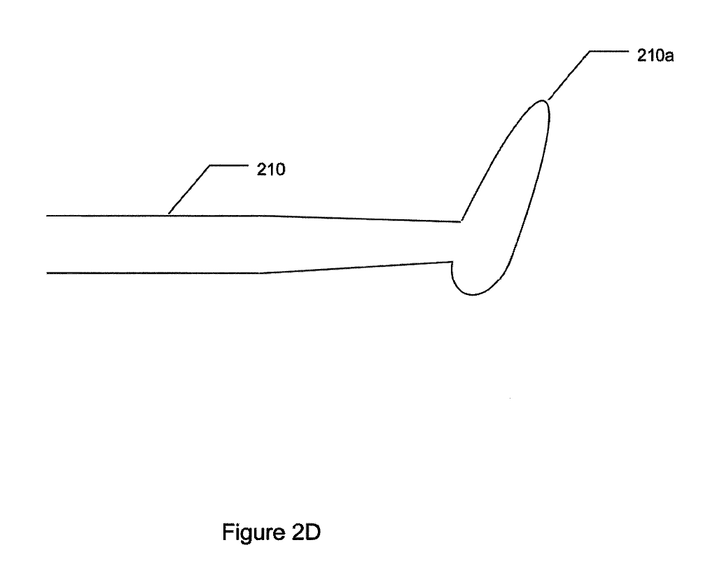

Refer to FIG. 2A, which is a cross-sectional drawing illustrating a hand-held dental tool with a single implement and an isolated weight according to an embodiment of the present invention.

As shown in FIG. 2A, the hand-held dental tool 200 of the present invention comprises a main body 210, an implement 230, and a weight 220.

The main body 210 comprises a malleable material such as, for example, a plastic material and is molded into a shape to form a body for the dental professional to grasp.

A portion 230a of the implement 230 is molded inside the main body 210. The remainder of the implement 230 extends outside the main body 210. This remainder comprises the actual tool used by the dental professional to perform procedures. In the embodiment illustrated in FIG. 2A the implement is a hooked scraper. In other embodiments of the present invention the implement comprises a hooked scraper, mirror, packer, curl, file, flattened end, pick, trowel, or other tools used by dental professionals

The weight 220 is molded inside the main body 210 of the hand-held dental tool 200. In this embodiment the weight 220 is isolated from the implement 230. The weight 220 provides the hand-held dental tool 200 with a relative weight. Without the weight 220 the hand-held dental tool 200 would feel too light and the dental professional would be required to adjust their technique in order to use the tool.

Since the main body 210 comprises an inexpensive material, the hand-held dental tool 200 has a low cost and can be disposed of after use. As a result, the hand-held dental tool of the present invention is inexpensive to produce and purchase, eliminates the need for sterilization procedures, and protects a patient's health.

Refer to FIG. 2B, which is a cross-sectional drawing illustrating a hand-held dental tool with two implements and an isolated weight according to an embodiment of the present invention.

In the embodiment illustrated in FIG. 2B the hand-held dental tool 200 comprises a first implement 230 and a second implement 231. A portion 230a of the first implement 230 and a portion 231a of the second implement 231 are molded inside the main body 210 leaving the remainder of the first implement 230 and second implement 231 exposed or protruding from the main body 210.

A weight 220 is disposed inside the main body 210 to provide a relative weight to the hand-held dental tool 200.

Since the hand-held dental tool 200 in this embodiment comprises two implements 230 231, the value of the tool is increased as the professional does not have to pick up a separate tool.

Refer to FIG. 2C, which is a cross-sectional drawing illustrating a hand-held dental tool with two implements and an isolated weight according to an embodiment of the present invention and to FIG. 2D, which is a side view drawing illustrating an angled implement of the hand-held dental tool of FIG. 2C.

In the embodiment illustrated in FIG. 2C the hand-held dental tool 200 of the present invention comprises a first implement 230 and a second implement 232. In this embodiment the second implement 232 is a mirror. The edge of the mirror is molded into a portion 210a of the main body 210 leaving the majority of the mirror exposed.

In some embodiments of the present invention the implement is angled in reference to the main body. For example, as shown in FIG. 2D, the mirror is positioned at an angle to allow the professional to more easily see behind teeth.

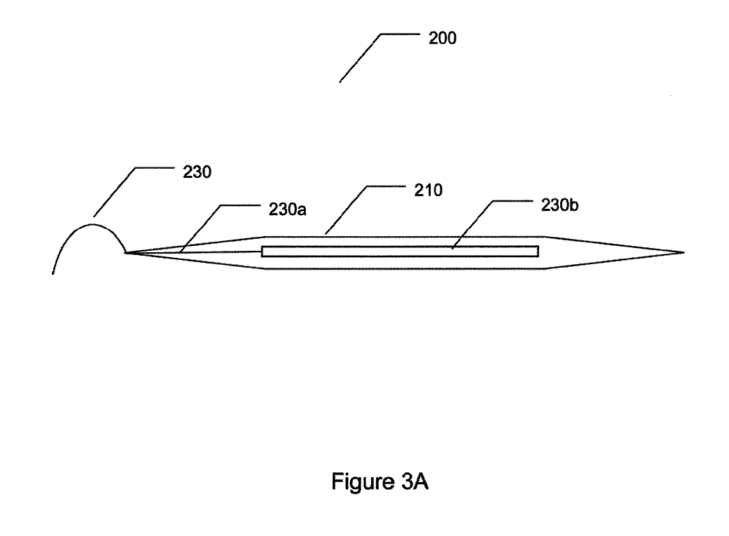

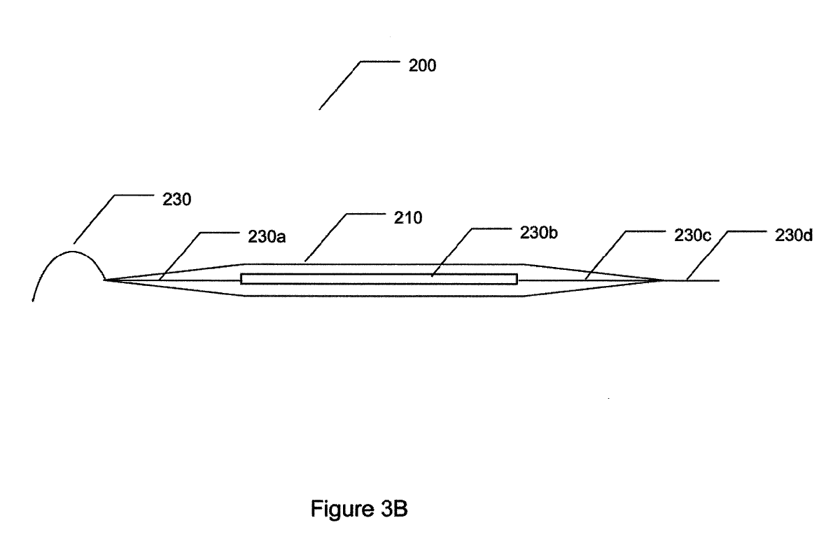

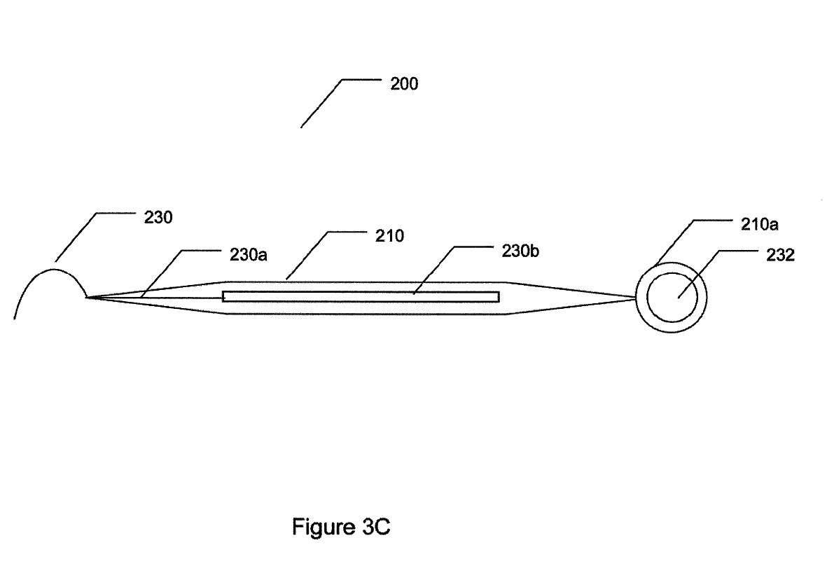

Refer to FIG. 3A, which is a cross-sectional drawing illustrating a hand-held dental tool with a single weighted implement according to an embodiment of the present invention.

In the embodiment illustrated in FIG. 3A, the hand-held dental tool 200 comprises a main body 210, an implement 230, and a weight 230b.

In this embodiment the implement 230 is attached to the weight 230b or comprised of the same material to form a single piece. The weight 230b and a portion 230a of the implement 230 are molded inside the main body 210. The remainder of the implement 230 is exposed and is used by professionals as the actual tool such as, for example, a scrapper for removing plaque from a patient's teeth.

In other words, a section 230a 230b of the single weighted implement is molded inside the main body 210 leaving the first implement 230 exposed.

Utilizing a single piece implement and weight or weighted implement can simplify manufacturing of the hand-held dental tool.

Refer to FIG. 3B, which is a cross-sectional drawing illustrating a hand-held dental tool with a double ended weighted implement according to an embodiment of the present invention.

In the embodiment illustrated in FIG. 3B the hand-held dental tool 200 comprises a main body 210, a first implement 230, a second implement 230d, and a weight 230b.

In this embodiment the first implement 230 and the second implement 230d are attached to the weight 230b or formed in a single piece. For example, the first implement 230, the second implement 230d, and the weight 230b comprise the same material and are manufactured in one piece to form a double ended weighted implement.

A portion 230a of the first implement 230 and a portion 230c of the second implement 230d and the weight 230b are molded inside the main body 210. In other words, a section 230a 230b 230c of the double ended weighted implement is molded inside the main body 210 leaving the first implement 230 and the second implement 230d exposed.

Refer to FIG. 3C, which is a cross-sectional drawing illustrating a hand-held dental tool with a single weighted implement and a second implement which is a mirror according to an embodiment of the present invention.

The embodiment illustrated in FIG. 3C is similar to the embodiment of FIG. 2C where the hand-held dental tool 200 comprises a first implement 230 and a second implement 232.

However, in the embodiment illustrated in FIG. 3C, the hand-held dental tool 200 comprises a first implement 230 and a weight 230b that are attached to each other or manufactured in a single piece to form a weighted implement.

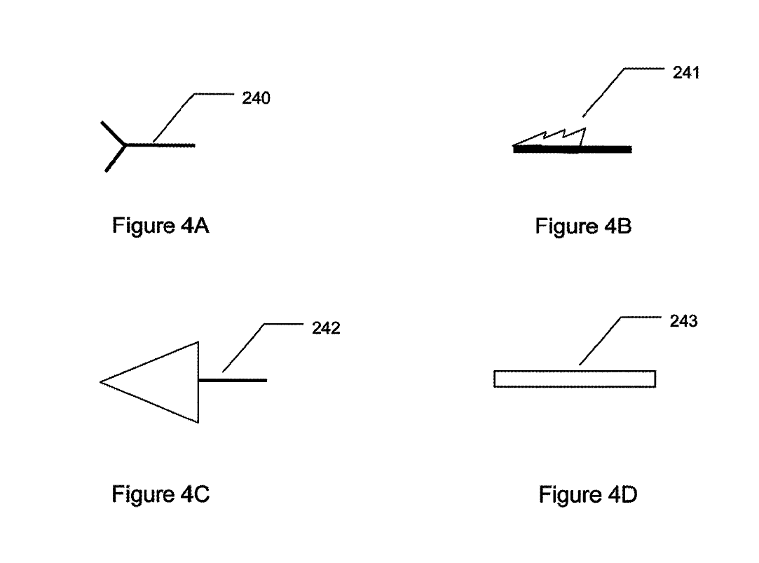

Refer to FIGS. 4A-4D, which are drawings illustrating additional implements according to embodiments of the present invention.

In embodiments of the present invention the implement comprises a hooked scraper, mirror, packer (FIG. 4A), curl, file (FIG. 4B), flattened end (FIG. 4D), pick, trowel (FIG. 4C), or other tools used by dental professionals.

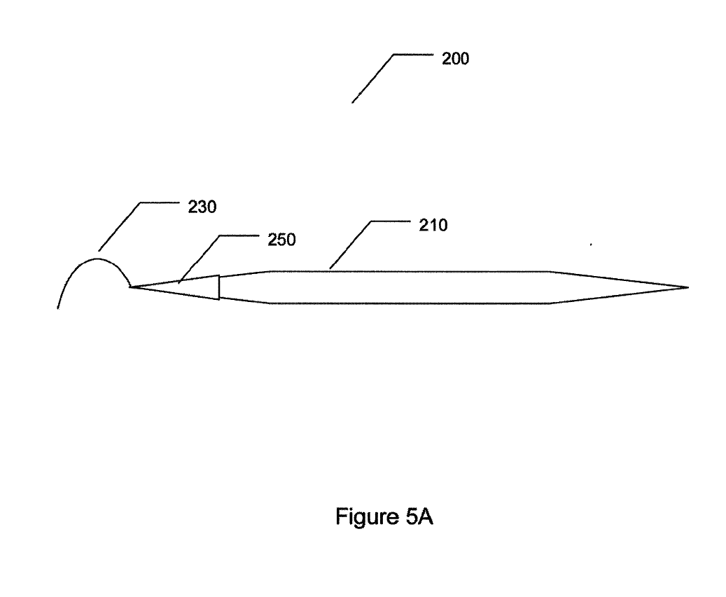

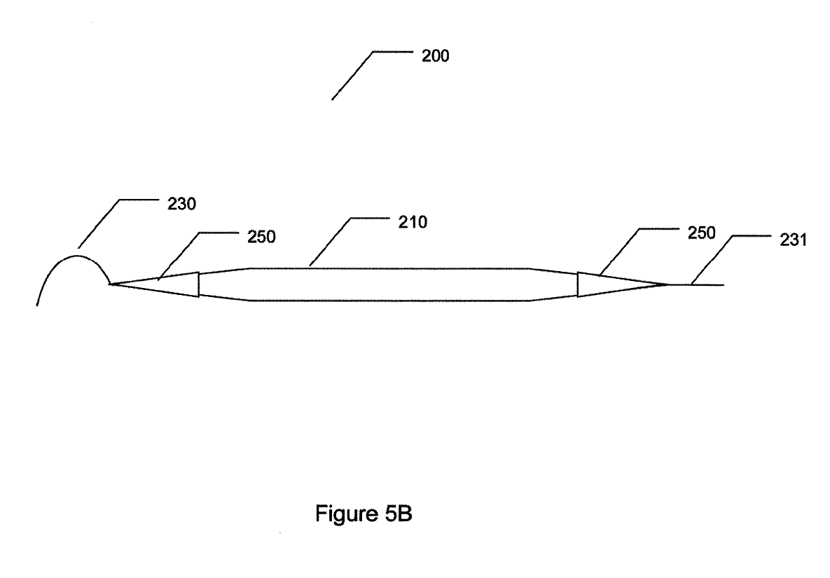

Refer to FIG. 5A, which is a drawing illustrating a single ended hand-held dental tool with use indicator according to an embodiment of the present invention.

The embodiment illustrated in FIG. 5A is similar to the embodiments in FIG. 2A and FIG. 3A where the weight (not shown) and a section or portion (not shown) of the implement 230 are molded inside the main body 210.

However, in the embodiment illustrated in FIG. 5A the hand-held dental tool 200 of the present invention further comprises a use indicator 250 attached to the main body 210. The use indicator 250 acts as a sensor to detect and indicate if the dental tool 200 has been used. In this way a patient can easily confirm whether or not the dental tool 200 has been previously used on another patient.

When the implement 230 of the dental tool 200 enters a patient's mouth the use indicator 250 makes contact with the patient's gums, teeth, lips, cheeks, tongue, or other parts of the mouth, or saliva, blood, or plaque. The properties or characteristics of the material used in the use indicator 250 will cause the use indicator 250 to change visually. For example, if the use indicator 250 is originally white and once the use indicator 250 enters a patient's mouth and makes contact with an area of the mouth, saliva in the mouth, blood in the mouth, or plaque, the use indicator 250 will change color.

The material used in manufacturing the use indicator 250 comprises a material or chemical compound with characteristics or properties that allow the material or chemical compound to change properties when encountering saliva, blood, or plaque.

For example, a litmus material or mixture is used in an adhesive tape and adhered to the main body of the dental tool near the implement. When the water-soluble litmus mixture contacts saliva the color of the use indicator will change.

Or, for example, an easily dissolve-able material is used as the use indicator. When the use indicator encounters moisture such as blood or saliva the material will start to dissolve. A patient or professional can easy see the deterioration of the use indicator and identify that the dental tool has been previously used.

Or. For example, an absorbent material is used as the use indicator. When the use indicator encounters blood, the blood is absorbed into the use indicator and a portion of the use indicator turns red from the blood stain.

In some embodiments of the present invention the use indicator extends over part or the entire exposed portion of the implement. In this way, when the implement makes contact inside the patient's mouth the use indicator will visually indicate that the dental tool has been used.

FIG. 5B is a drawing illustrating a double ended hand-held dental tool with use indicator according to an embodiment of the present invention.

The embodiment illustrated in FIG. 5B is similar to the embodiment of FIG. 5A. However, in the embodiment illustrated in FIG. 5B comprises two implements 230 231 and two use indicators 250. In this embodiment when either of the two implements 230 231 are used one of the use indicators 250 will indicate that the dental tool 200 has be used.

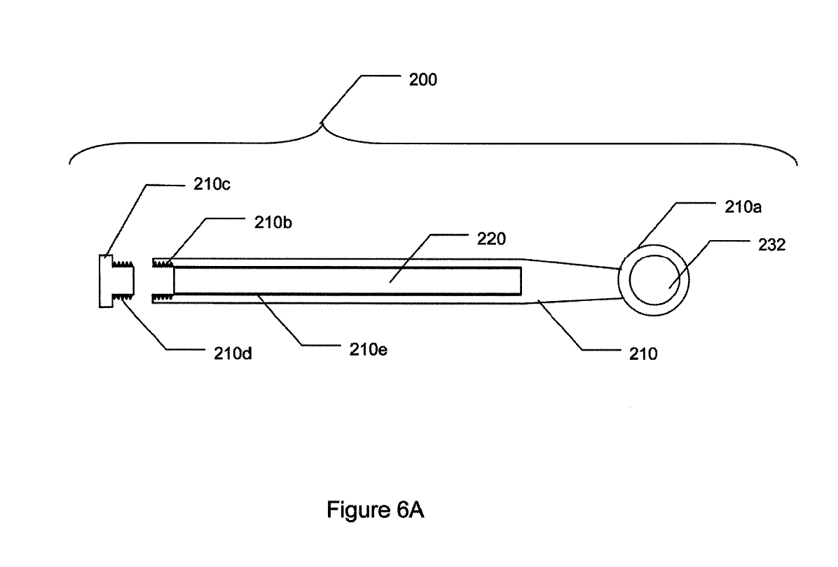

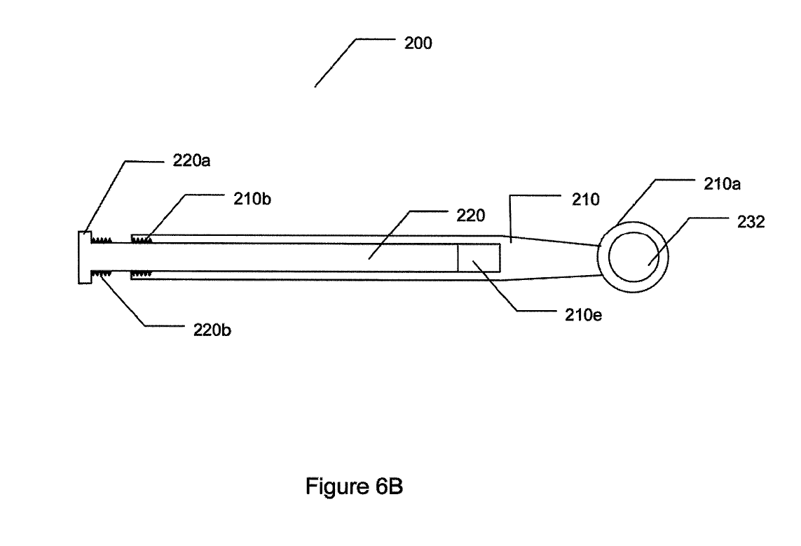

Refer to FIG. 6A, which is a drawing illustrating a dental tool with threaded main body and main body cap according to an embodiment of the present invention.

In the embodiment illustrated in FIG. 6A the disposable dental tool 200 of the present invention further comprises a molded main body 210 and a main body cap 210c. The molded main body 210 comprises a hollow chamber 210e and a threaded main body end 210b. The main body cap 210c further comprises cap threads 210d for mating with the threaded main body end 210b. A weight 220 is inserted into the hollow chamber 210e and the main body cap 210c is screwed into the main body 210 to retain the weight 220. After using the dental tool 200, the main body cap 210c is unscrewed and the weight 220 is removed. The main body 210 with implement 232 and the main body cap 210c are then disposed of and the weight 220 is kept for further use. Since the weight 220 is reusable the cost of the dental tool 200 is reduced.

Refer to FIG. 6B, which is a drawing illustrating a dental tool with threaded main body and threaded weight according to an embodiment of the present invention.

In the embodiment illustrated in FIG. 6B the disposable dental tool 200 of the present invention further comprises a molded main body 210 and a threaded weight 220. The molded main body 210 comprises a hollow chamber 210e and a threaded main body end 210b. The threaded weight 220 comprises a weight cap 220a and weight threads 220b for mating with the threaded main body end 210b. The threaded weight 220 is inserted into the hollow chamber 210e and the weight threads 220b are screwed into the threaded main body end 210b of the main body 210 to retain the threaded weight 220. After using the dental tool 200, the threaded weight 220 is unscrewed and removed. The main body 210 with implement 232 is then disposed of and the threaded weight 220 is kept for further use.

In the embodiments illustrated in FIG. 6A and FIG. 6B the implement comprises a mirror. However, in other embodiments other implements are utilized.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

1. A disposable hand-held dental tool comprising:
a plastic main body, the plastic main body comprising an unthreaded hollow chamber;
an isolated weight inside the unthreaded hollow chamber of the plastic main body, the isolated weight not connected to the plastic main body; and
an implement with a portion of the implement molded inside the plastic main body leaving another portion of the implement exposed, the implement not connected to the isolated weight;
wherein the isolated weight is removed from the plastic main body for future use after the disposable hand-held dental tool has been used and the plastic main body and the implement are disposed of.

2. (canceled)

3. (canceled)

4. (canceled)

5. The disposable hand-held dental tool of claim 1 further comprising:
a plastic main body cap retaining the isolated weight, the plastic main body cap comprising threads to mate with threads of the plastic main body.

6. (canceled)

7. The disposable hand-held dental tool of claim 1 further comprising:
a use indicator for indicating that the disposable hand-held dental tool has been used on a patient a single time.

8. The disposable hand-held dental tool of claim 7 the use indicator comprising a water-soluble material or mixture that changes color on contact with saliva or blood.

9. The disposable hand-held dental tool of claim 7 the use indicator comprising dissolve-able material that dissolves on contact with saliva or blood.

10. The disposable hand-held dental tool of claim 1 further comprising:
a use indicator disposed on the main body for indicating that the disposable hand-held dental tool has been used on a patient once.

11. (canceled)

12. A disposable hand-held dental tool comprising:
a plastic main body, the main body comprising an unthreaded hollow chamber;
an isolated weight inside the unthreaded hollow chamber of the plastic main body, the isolated weight not connected to the plastic main body;
an implement with a portion of the implement molded inside the plastic main body leaving another portion of the implement exposed, the implement not connected to the isolated weight; and
a use indicator for indicating that the disposable hand-held dental tool has been used a single time;
wherein the isolated weight is removed from the plastic main body and retained for future use after the disposable hand-held dental tool has been used and the plastic main body, the implement, and the use indicator are disposed of to prevent re-use.

13. The disposable hand-held dental tool of claim 12 the use indicator comprising a water-soluble material or mixture that changes color on contact with saliva or blood.

14. The disposable hand-held dental tool of claim 12 further comprising:
a plastic main body cap for holding the isolated weight inside the unthreaded hollow chamber of the main body, the plastic main body cap comprising cap threads for mating with main body threads.

15. (canceled)

16. (canceled)

17. (canceled)

18. A disposable hand-held dental tool comprising:
a plastic main body, the main body comprising an unthreaded hollow chamber;
an isolated metal weight inside the unthreaded hollow chamber of the plastic main body, the isolated metal weight not connected to the plastic main body;
a plastic main body cap for retaining the isolated metal weight inside the unthreaded hollow chamber;
an implement with a portion of the implement molded inside the plastic main body leaving another portion of the implement exposed, the implement not connected to the isolated metal weight; and
a use indicator for indicating that the disposable hand-held dental tool has been used once, the use indicator comprising a water-soluble material or mixture that changes color or dissolves on contact with saliva or blood after a single use;
wherein, after the disposable hand-held dental tool has been used once, the plastic main body cap is removed from the plastic main body; the isolated metal weight is removed from the plastic main body; and the plastic main body, the plastic main body cap, the implement, and the use indicator are disposed of and the isolated metal weight is retained for future use in a previously unused disposable hand-held dental tool.

19. (canceled)

20. (canceled)
